(19) United States
(12) Patent Application Publication
(10) Pub. No.: US 2021/0082058 A1
(43) Pub. Date: Mar. 18, 2021

(54) BIOMETRICS AND PREDICTIVE MODELING AND MONITORING SYSTEM FOR HEALTH RISK ASSESSMENT

(71) Applicants: Bruce Miller, Jacksonville, FL (US); Scott C. Snyder, Jacksonville, FL (US)

(72) Inventors: Bruce Miller, Jacksonville, FL (US); Scott C. Snyder, Jacksonville, FL (US)

(73) Assignee: Prospective Risk Management LLC, Jacksonville, FL (US)

(21) Appl. No.: 17/106,760

(22) Filed: Nov. 30, 2020

Related U.S. Application Data
(63) Continuation-in-part of application No. 15/945,164, filed on Apr. 4, 2018.
(60) Provisional application No. 62/481,552, filed on Apr. 4, 2017.

(51) Int. Cl. G06Q 40/08; G06F 16/23

(52) U.S. Cl. CPC G06Q 40/08; G06F 16/2379

(57) ABSTRACT

The present invention relates to methods and apparatus for generating create and maintain very efficient ‘preferred collateralized risk health plans’ with very rich benefit offerings at the best price points possible. More specifically, the present invention presents methods and apparatus for generating a means for providing health care services to smaller groups of participants by grouping like participants into larger plan groups.

### FIELD OF THE INVENTION

The present invention relates to methods and apparatus for creating models indicating a health care risk associated with the use of biometrics on various groups. More specifically, the present invention presents methods and apparatus for aggregating smaller groups, collecting biometric data and grouping according to similar health risk into larger groups in order to better manage the provision of health services to the members of the smaller groups. As described herein, a group may include one or more of: employees of a same company, a member of an association, members of a club or other definable organization.

### BACKGROUND OF THE INVENTION

Provision of health care services to a general population has proven to be an ongoing challenge. Small businesses employ roughly 50% of the private workface in the United States. Companies with fewer than 100 employees have the largest share of small business employment and continue to gain in both number of employees and share of U.S. employees.

In addition, the workforce is generally aging, which can lead to additional need for health care services unless good health care is consistently available to the workforce. One problem with providing adequate health care services is the cost of health care insurance to employees of small companies as compared to the economies of scale enjoyed by Fortune Fifty companies. The relative cost differential proves detrimental to a large percentage of the population.

### SUMMARY OF THE INVENTION

Accordingly, the present invention combines methods and apparatus into systems that extend the availability of health care services to the segment of the population involved with small companies with biometric, real time and historical data. The present invention draws upon ongoing characterization of small groups of employees wherein each small group has its own unique health risk profile that is quantified with actuarial models that measure demographic (age/gender) scores, claims histories, ongoing significant medical conditions and other factors. The results of this evaluation allow automated systems to determine what the risk of a “prospect” small group relative to an overall large group as a whole. This comparison allows the systems and apparatus to assign one of multiple “rate tiers”; i.e., variable premium rates assigned to a group to match up to the risk they represent. In general, as described herein a “rate” may be seen to represent a financial indicator of a risk associated with the provision of health care services to the population of coverage participants. This is to assure that the large multiple employer group is collecting an adequate amount, on average, to pay both claims costs and administrative costs for the year. This process also determines if a particular small group meets minimum standards to be a good enough candidate to participate in a particular large plan at all. In some embodiments, an initial process of segregation becomes an important component part of what enables filed insurance program of the present invention to be effective, and available.

The details of one or more examples of the invention are set forth in the accompanying drawings and the description below. The accompanying drawings that are incorporated in and constitute a part of this specification illustrate several examples of the invention and, together with the description, serve to explain the principles of the invention: other features, objects, and advantages of the invention will be apparent from the description, drawings, and claims herein.

### BRIEF DESCRIPTION OF THE DRAWINGS

The accompanying drawings, that are incorporated in and constitute a part of this specification, illustrate several embodiments of the invention and, together with the description, serve to explain the principles of the invention:

FIG. 1 illustrates a block diagram of present inventions with directional aggregated data according to some embodiments of the present invention.

FIG. 2 illustrates an exemplary aggregation of risk company populations in a top-down representation.

FIG. 3 illustrates an exemplary flow diagram according to some implementations of the present invention.

FIG. 4 illustrates some additional method steps present in some exemplary embodiments of the invention.

FIG. 5 illustrates some additional exemplary embodiments of aspects of the invention.

FIG. 6 illustrates apparatus that may be present invention to implement aspects of the present invention including executable software.

FIG. 7 illustrates an exemplary automated device that may be used to implement aspects of the present invention including aspects that may be implemented via executable software.

### DETAILED DESCRIPTION

The present invention provides generally for the generation, modeling, capture, and retention of data relating to health care services and financial backing for health care services, including performances in a specific equipment and predicative analysis of a population of workers or other participants in order to adequately arrange for health care services.

Included in the present invention are methods and apparatus to independently provide Actuarial Services and Risk Assessment. The services may include multiple types of vehicles for providing health care services, and may be described in terms of sponsors of Group Health & Welfare Benefits plans, on both a single employer sponsor and Multiple Employer Plan basis. The latter includes a very complex sub-set of the overall employer plan market.

One aspect of the present invention creates and maintains very efficient “preferred risk health plans” with very rich benefit offerings at the best price points possible.

Services may be complementary to Consulting Services offered in conjunction with managed plans that may exceed several billion dollars in health insurance premiums and premium equivalents, which are normally out of reach to small companies.

Techniques to record data, such as, by way of non-limiting example: data indicative of, or representative of, or conducive to analysis to generate a risk profile of typically smaller employer companies wishing to enjoy the economies of scale created in larger groups. As such, the present invention creates one or more large multiple employer plans, consisting of hundreds to thousands of smaller employer sub groups.

Each small group may have its own unique health risk profile that may be quantified with actuarial models that measure demographic (age/gender) scores, claims histories, ongoing significant medical conditions and other factors.

The results of evaluation allow the present invention to determine what the risk of a prospect small group is relative to the overall large group as a whole. This comparison allows present invention to assign one of dozens of “rate tiers”; i.e., variable premium rates assigned to a group to match up to the risk they represent. This is to assure that the large multiple employer is collecting an adequate amount, on average, to pay both claims costs and administrative costs for the year. This process also determines if the small group is even a good enough candidate to participate in the large plan at all. One skilled in the art will understand that this initial process is an important component part of what enables a filed insurance program according to the present invention to be effective, and available in the first place

In addition, data may be collected, retained analyzed, and referenced to project health care provision performance.

Such data may also be combined with user and/or health care provider and/or health care risk assumers, specifications and historical data to model expectations related to actual operation of the facility.

In the following sections, detailed descriptions of examples and methods of the invention will be given. The description of both preferred and alternative examples though through are exemplary only, and it is understood that to those skilled in the art that variations, modifications and alterations may be apparent. It is therefore to be understood that the examples do not limit the broadness of the aspects of the underlying invention as defined by the claims.

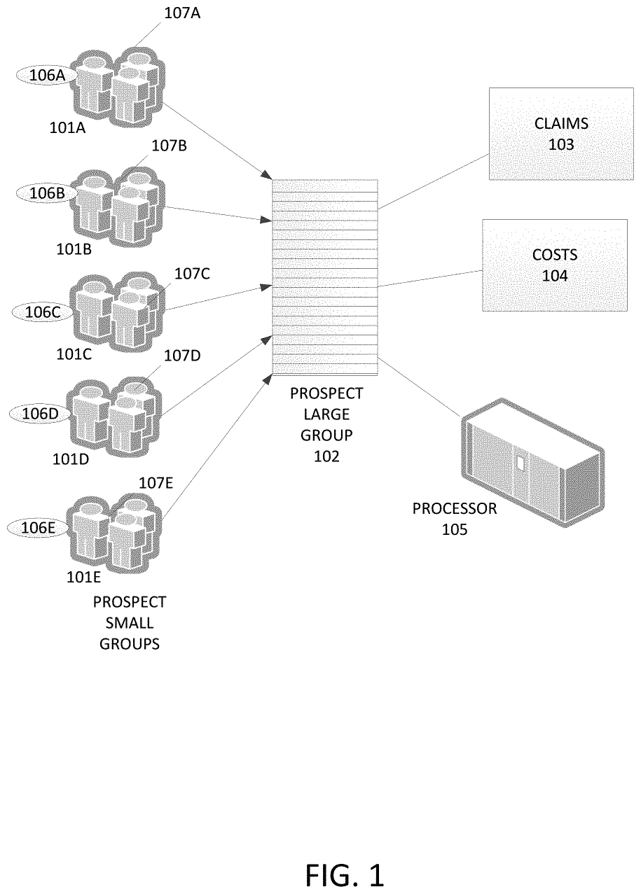

Referring now to FIG. 1, multiple small groups 101A-E of plan participants 107A-E and associated biometric data 106A-E are aggregated into one or more models of a prospect large group 102. Based upon data gathered and analyzed and modeled in an automated processor 105 (various embodiments of which are described in enabling detail below). The automated processor 105 generates one or both of estimated claims and calculated costs of health care services for the group.

As part of this process, prospect small groups may be sorted into a prospect large group based on a characterization or risk factor. By way of non-limiting example, five prospect small groups 101A-E may request entry into prospect large group. Respective biometric data 106-E may be collected and submitted for all or some of the small group 101A-E participants 107A-E. As used herein, biometric data may include a biological based measurement that ascertains an identity of a participant 107A-E, or a quantification of a physiological state of the participant 107A-E, such as heart rate, blood pressure, blood oxygen level, vaccinations received by the participants 107A-E and the like. Each of the small groups may be designated, by processor 105, by small employer or by one or more risk factors, such as age, preexisting condition, smoking, etc. Based on that designated, each small group may be assigned a rate tier by processor 105. For example, if the prospect small groups 101A-E are characterized by age, then 1-5 tiers of insurance rates could be assigned to the prospect small groups 101A-E. Each prospective small group 101A-E may be sorted into the appropriate tier based on the age of the members of the small group. Accordingly, rate tiers may be formed with respect to one or more risk criteria. The designation may also occur through a plan administrator, who may use an application on a smart phone to select one or more categories of risk factors for sorting into risk tiers

A benefit to this system is that claims 103 and costs 104 may be attributed to prospect large group 102 as a whole, where such claims 103 or costs 104 may have overwhelmed each individual prospect small group 101A-E.

A processor may also be functional to provide predictive modeling of ongoing risk profiles of member companies in a multiple employer plan. The present invention may use jointly developed and modified actuarial models to use actual claims data (on medical and drug claims) to determine future risk associated with the prospect small groups 101A-E within the multiple employer plan (i.e., prospect large group 102). According to some embodiments, in order for overall multiple employer plan to remain viable, and have attractive overall premium rates, a mechanism provides for adequate premiums to be collected at the small group level to properly fund plan operations, which in turn provides for the provision of health care services. It is determined in this process what that adequate level is, or if a group can even meet participation guidelines. Various predictive analytics of the present invention enable a process to determine pricing of “specific stop loss” policies involved in insurance filing.

According to some implementations, such calculations may be performed periodically (e.g., monthly, bimonthly) and may use changes in these results to adjust the amount of Irrevocable Letters of Credit or other instrument used as the funding platform for collateral required by carrier partners.

Implementations may also include a Calculation of Premium Rates for the coming year. This is a combination of Predictive Risk Modeling and overall traditional actuarial calculations of funding rates for the master plan. This is far more complex than the traditional analysis by virtue of the multiple employer nature of the plan.

Still further implementations may include ongoing monitoring of plan funding surplus (deficit). Apparatus of the present invention may receive actual complete and unedited universal claim files (and Census files) from carrier partners on a monthly basis, so the system may monitor ongoing funding of premiums versus actual incurred claims. In some embodiments, this process may become quite complex, as it requires significant big-data database processes to manage. This set of processes may be integral to a unique financial guaranty created in the present invention.

In some embodiments, Underwriting and pricing of Specific Stop Loss/Pooling insurance coverage may be generated according to the method steps of the present invention and include specific Stop Loss and Pooling coverages including two similar types of insurance contracts that limit the liability of the plan sponsor on any one single claim.

In such implementations, various types of coverage may exist primarily in the “Self-Funded” insurance world, as opposed to traditional fully insured marketplace where a plan sponsor trades a fixed monthly premium for ‘no recourse’ freedom from potentially unlimited claims. We are now nearing the focus of our newly approved insurance coverage. Our process Centers on our ability to analyze and price the Specific Stop Loss insurance policy not based on the entirety of the history of the multiple employer plans, but only those participants currently enrolled and will be participating in the current year. This is another ‘big data’ process literally involving Gigabytes of claims data and actuarial expertise to create. It allows an insurance carrier to be provided with a view into the future based on current employee participation, not historical data that includes many smaller employers that have previously left the program. This allows for the best possible measurement of risk, and is a process unique to the processes and apparatus of the present invention.

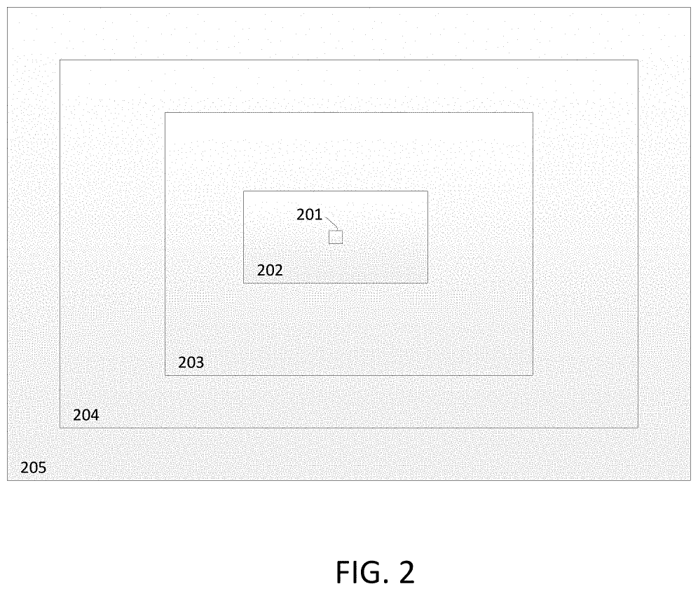

Referring now to FIG. 2, a virtual model that correlates with an aggregation of smaller groups 201 of plan participants, such as the members of a single small entity which may include and/or consist of, one or more of: a company, group, club, association or other definable set of participants, including eligible family member's dependents and domestic partners. In some embodiments, a small group 201 may be included in progressively larger groups 202-205 and analyzed to determine an optimum group size and acceptable participants for achieving a defined purpose. The defined purpose may include, by way of non-limiting example, provision of health care services on a self-insured basis.

A designation of a “small entity” may be according to the United States government guidelines and include five hundred (500) persons or less. Other embodiments may include a ratio of small entities to large entities. A small entity (sometimes referred to as a small group) may be for example one or more magnitudes less than the large entity. Accordingly, a small entity may include five hundred (500) persons or less and a large entity (sometimes referred to as a large group) include five thousand (5,000) persons or more.

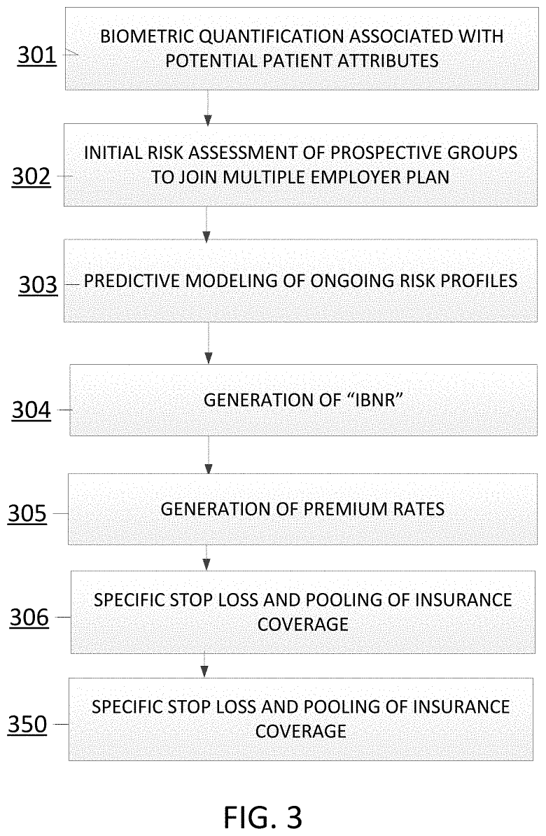

Referring now to FIG. 3, a flow chart describes some exemplary steps that may be performed in the practice of the present invention. The method steps described may be performed by an automated apparatus, as described herein.

At step 301 biometric quantifications are associated with potential patient attributes. Biometric quantification may be directed towards identification of a patient, such as a retinal scan, fingerprint, facial recognition and the like, or quantify a physiological state of the patient, such as, by way of non-limiting example, a heartrate, body or skin temperature, blood oxygen level, or vaccination receipt.

At step 302, an initial risk assessment of prospective participants formed into smaller groups is accomplished. The assessment may include, in some exemplary embodiments, the suitability of a group of participants as members of a larger group. The larger group may include a multiple employer plan. The term “employer” may be interpreted to include member of other groups, such as club members, associations and the like and is not necessarily limited to those in a legal arrangement of employee and employer. Accordingly, other groups of plan participants may be included in the present invention. Performance of a plan may be analyzed, calculated and modeled. Still other embodiments may include securitization of pooled risk which may in turn be marketed, such as for example via trading as a security on n exchange. With such a security, a year end surplus may be translated into a profit and a deficit into a loss.

At method step 303 modeling of ongoing risks profiles may be conducted. Modeling may provide one or more indicators of performance of a model for a given defined group. As presented herein, “performance” may include one or more of: total cost of health care services provided; total quality of health care services provided or pecuniary amounts generated and/or saved as a result of the methods and processes provided and/or described or suggested herein. Additionally, the risk profiles may monitor a risk performance. For example, if the rate tiers are based on the risk criteria of age, and the costs/premium ratio decreases for the 20-29 age group, then a corrective action may occur. This may include a change in rates, premiums, risk parameters, or other factors.

By way of non-limiting example, functions of the methods and apparatus of the present invention presented herein may include one or more of the following factors that may be modeled and/or tracked over a defined period of time, such as, for example, an expected life of a plan and responsibilities to provide for health-related services.

At method step 304, a calculation of an IBNR may be performed. IBNR may include, in some embodiments, analysis includes: Calculation of “Incurred but Not Reported” (“IBNR”) claims. This analysis provides for actuarial certification to measure levels of pending but yet unpaid insurance claims “in the pipeline” but not yet known. Similarly, this may better assist in determining the overall risk profiles of a group in a rate tier. A probability of INBR claims ultimately becoming reported claims may be used as part of this determination. In such embodiments, this may include an important part of determining a level of collateral designated for a preferred insurance carrier. This type of analytic according to processes utilized by actuaries and accountants, but is more complex to measure on multiple employer plans with widely scattered populations of participants.

At method step 305 a premium rate may be generated for one or more of: individual participants, small groups, and larger groups comprising multiple small groups. The premium rate may be based on actuarial tables and may consider factors such as the IBNR rate of the individual participants, small prospect groups, and large prospect groups comprising the multiple small groups.

At method step 306 specific stop loss and pooling of insurance coverage may be generated for various defined groups.

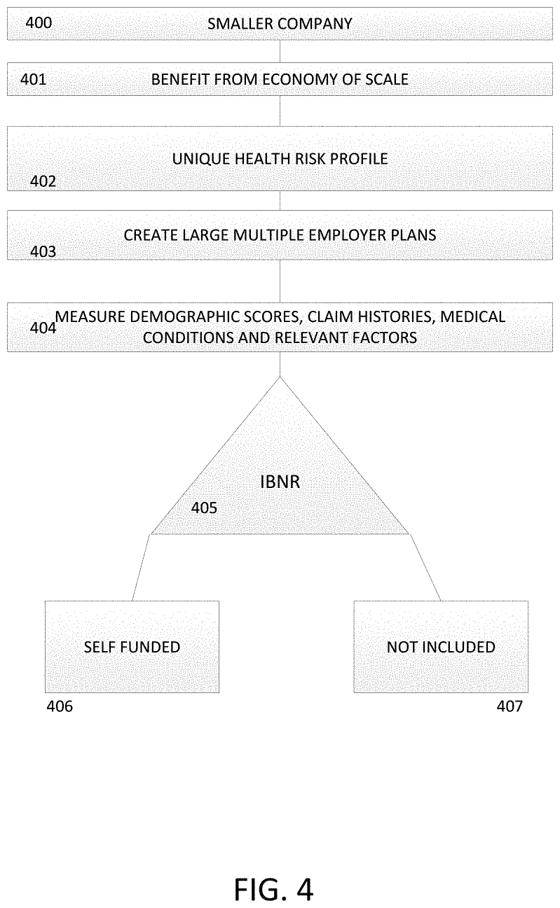

Referring now to FIG. 4, aspects of the present invention are illustrated to emphasize benefits of the processes and apparatus described herein. In general, at 400 a smaller company may benefit 401 from an economy of scale resulting from combing with other plan participants. At 402, the combined participants may be be used to generate a unique health risk profile, and at 403 one or more large multiple “employer” plans are created.

At 404 analyses may be performed based upon measured demographic scores, claim histories, medical condition and other relevant factors. Design aspects of an aggregated group plan before build can have important effects as to which small groups are selected for involvement in a larger grouped plan.

At 405 an IBNR amount may be used to determine if participants are self-funded in a larger group 406 or no longer included 407 in a larger group. For example, a high rate of IBNR claims may be suggestive of alternative insurance by the group.

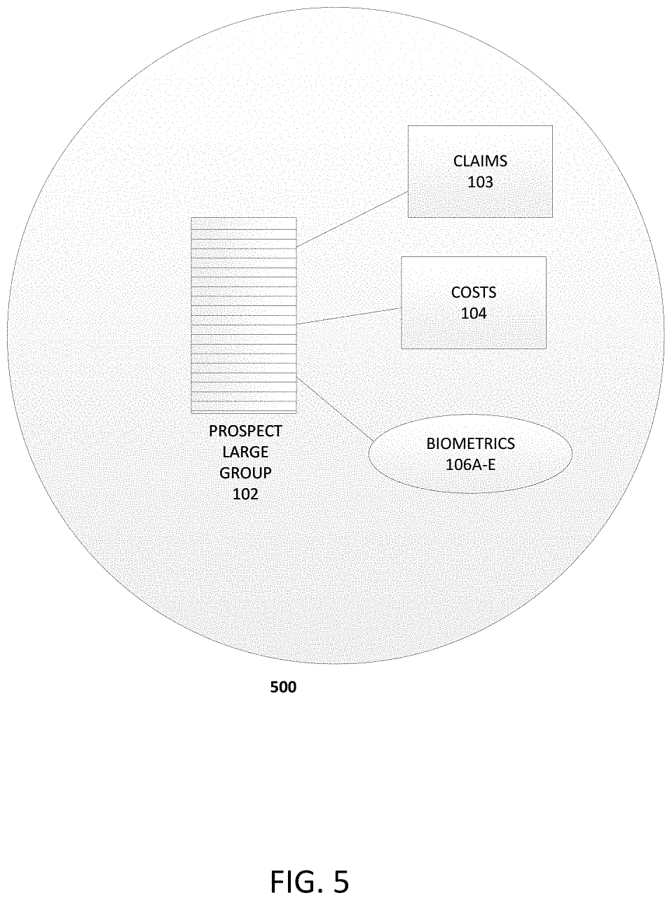

Referring now to FIG. 5, component parts discussed herein may be used to manage large, complex and dynamic multiple employer plans 500. Component parts may include, for example, a prospect large group, claims 103, costs 104, and associated biometrics 106A-E.

A new filed insurance policy may include a next step insurance concept that allows the financial advantages and significant cost savings available in self-insured plans to be used in a secure, guaranteed manner much like traditional fully insured plans. An insurance carrier may financially guarantee a large amount of claim liability from risk of plan sponsor insolvency. This guaranty of claim obligations is coveted by state and federal regulators—and by plan participants—who could be left with nothing in the event of plan sponsor insolvency.

In many cases, a carrier may be unwilling to offer this coverage without the engagement of an overseeing entity, such as entity 500, to provide the above illustrated independent watchdog oversight on these large health plans. The plans themselves may be generated to be 10%-20% less expensive than their fully insured counterparts, which is a significant amount in today's costly insurance marketplace. The present invention may anticipate the participation of over 200,000 employees and their families in this program within the first year of operation.

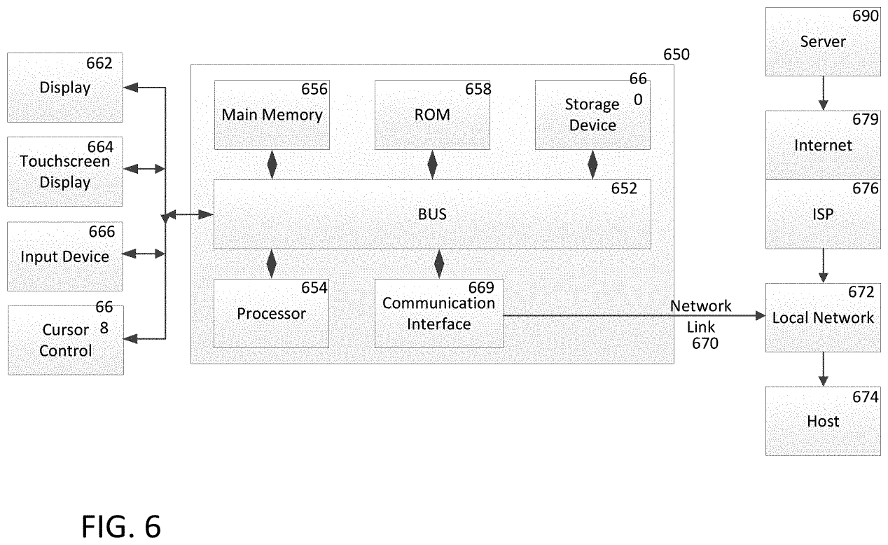

FIG. 6 illustrates an automated controller that may be present invention to implement various aspects of the present invention, in various embodiments, and for various aspects of the present invention, controller 600 may be included in one or more of: a wireless tablet or handheld device, a server, a rack-mounted processor unit. The controller may be included in one or more of the apparatus of present invention described above, such as the Revolver Server, and the Network Access Device. The controller 600 comprises a processor unit 610, such as one or more semiconductor based processors, coupled to a communication device 620 configured to communicate via a communication network (not shown in FIG. 6). The communication device 620 may be present to communicate, for example, with one or more online devices, such as a personal computer, laptop, or a handheld device. Communication may be made across a digital communication network, such as the Internet.

The processor 610 is also in communication with a storage device 630. The storage device 630 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 630 can store a software program 640 for controlling the processor 610. The processor 610 performs instructions of the software program 640, and thereby operates in accordance with the present invention. The processor 610 may also communicate with the communication device 620 to transmit information, including, in some instances, control commands to operate apparatus to implement the processes described above. The storage device 630 can additionally store related data in a database 650 and database 660, as needed.

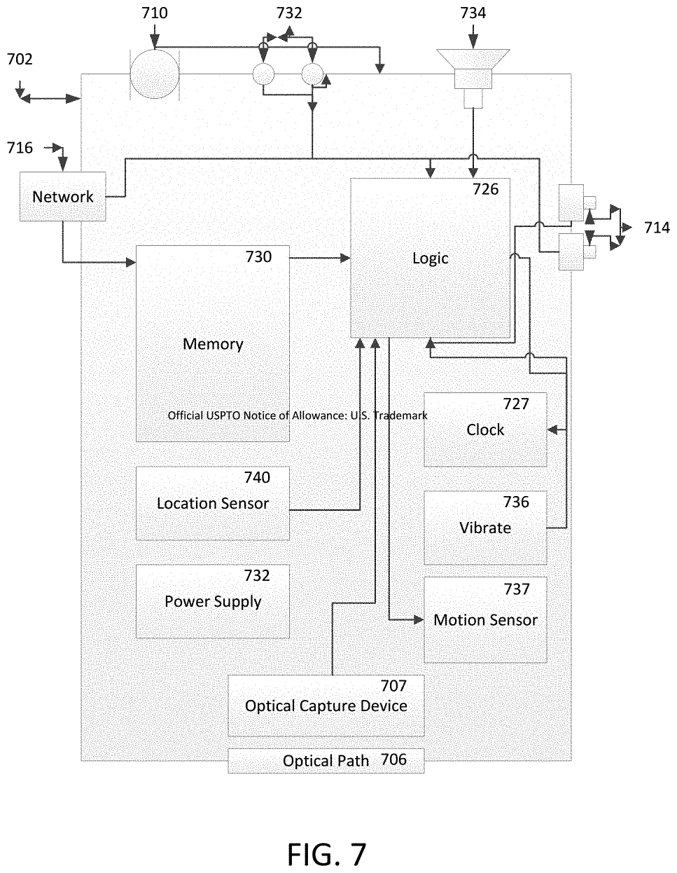

Referring now to FIG. 7, a block diagram of an exemplary automated device 702 that may also be used to implement various aspects of the present invention, including, for example, communication with a plan administrator and/or plan participant. The automated device 702 may comprise an optical capture device 708 to capture an image and convert it to machine-compatible data, and an optical path 706, typically a lens, an aperture or an image conduit to convey the image from the rendered document to the optical capture device 708. The optical capture device 708 may incorporate a Charge-Coupled Device (CCD), a Complementary Metal Oxide Semiconductor (CMOS) imaging device, or an optical sensor of another type.

A microphone 710 and associated circuitry may convert the sound of the environment, including spoken words, into machine-compatible signals. Input facilities 714 exist in the form of buttons, scroll wheels, or other tactile sensors such as touch-pads. In some embodiments, input facilities 714 may include a touchscreen display.

Visual feedback 732 to the present invention is possible through a visual display, touchscreen display, or indicator lights. Audible feedback 734 may come from a loudspeaker or other audio transducer. Tactile feedback may come from a vibrate module 736.

A motion sensor 738 and associated circuitry convert the motion of the automated device 702 into machine-compatible signals. The motion sensor 738 may comprise an accelerometer that may be present invention to sense measurable physical acceleration, orientation, vibration, and other movements. In some embodiments the motion sensor 738 may include a gyroscope or other device to sense different motions.

A location sensor 740 and associated circuitry may be present invention to determine the location of the device. The location sensor 740 may detect Global Position System (GPS) radio signals from satellites, or may also present invention assisted GPS where the mobile device may present invention a cellular network to decrease the time necessary to determine location. In some embodiments, the location sensor 740 may present invention radio waves to determine the distance from known radio sources such as cellular towers to determine the location of the automated device 702. In some embodiments these radio signals may be present invention in addition to GPS.

The automated device 702 comprises logic 726 to interact with the various other components, possibly processing the received signals into different formats and/or interpretations. Logic 726 may be operable to read and write data and program instructions stored in associated storage 730 such as RAM, ROM, flash, or other suitable memory. It may read a time signal from the clock unit 728. In some embodiments, the automated device 702 may have an on-board power supply 732. In other embodiments, the automated device 702 may be powered from a tethered connection to another device, such as a Universal Serial Bus connection.

The automated device 702 also includes a network interface 716 to communicate data to a network and/or an associated computing device. Network interface 716 may provide two-way data communication. For example, network interface 716 may operate according to the internet protocol. As another example, network interface 716 may be a local area network (LAN) card allowing a data communication connection to a compatible LAN. As another example, network interface 716 may be cellular antennae and associated circuitry which may allow the mobile device to communicate over standard wireless data communication networks. In some implementations, network interface 716 may include a Universal Serial Bus to supply power or transmit data. In some embodiments other wireless links may also be implemented.

As an example of one present invention of automated device 702, a reader may scan some coded information from a location marker in a facility with the automated device 702. The coded information may include, for example a hash code, bar code, RFID or other data storage device. In some embodiments, the scan may include a bit-mapped image via the optical capture device 708. Logic 726 can be stored in memory 730 with an associated time-stamp read from the clock unit 728.

Logic 726 may also perform optical character recognition (OCR) or other post-scan processing on the bit-mapped image to convert it to text. Logic 726 may optionally extract a signature from the image, for example by performing a convolution-like process to locate repeating occurrences of characters, symbols or objects, and determine the distance or number of other characters, symbols, or objects between these repeated elements. The reader may then upload the bit-mapped image (or text or other signature, if post-scan processing has been performed by logic 726) to an associated computer via network interface 716.

### CONCLUSION

A number of embodiments of the present invention have been described. While this specification contains many specific implementation details, there should not be construed as limitations on the scope of any inventions or of what may be claimed, but rather as descriptions of features specific to particular embodiments of the present invention.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous to the present invention.

Moreover, the separation of various system components in the embodiments described above should not be understood as requiring such separation in all embodiments, and it should be understood that the described program components and systems can generally be integrated together in a single software product or packaged into multiple software products.

The present invention, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous to the present invention. Nevertheless, it will be understood that various modifications may be made without departing from the spirit and scope of the claimed invention.

What is claimed is:

1. A method of generating risk models for relative groups of individuals, the method comprising the steps of:
a. storing multiple rate tiers in an automated database accessible via a digital communications network, each rate tier based upon a modeled risk, wherein the risk comprises risk factors comprising one or more of: age, smoking status, and preexisting condition;
b. using a processor to designate multiple combinations of risk criteria;
c. linking each combination of risk criteria with a rate tier in the automated database;
d. designating five hundred or less persons as a small entity;
e. linking one or more risk criteria with each person in the small entity;
f. linking biometric data with at least one person in the small entity;
g. repeating steps d. and f. for multiple small entities;
h. combining the multiple small entities to form a large entity; and
i. generating multiple risk models for the large entity based upon the number of persons in the large entity and the risk criteria for each person in the small entities.

2. The method of claim 1, further comprising the step of: calculating, via the processor, changes to the rate tier based upon periodic updates comprising risk factor values.

3. The method of claim 2 wherein the large entity comprises five thousand or more persons.

4. The method of claim 3 additionally comprising the step of modeling a risk performance for the small entity.

5. The method of claim 4 additionally comprising the step of modeling a risk performance for the large entity.

6. The method of claim 5 wherein the risk performance for the large entity outperforms the performance of the small entity.

7. The method of claim 6 wherein the performance comprises a total cost of health care services.

8. The method of claim 6 wherein the performance comprises a total quality of health care services.

9. The method of claim 6 additionally comprising the step of securitizing combined risk according to the multiple risk models for the large entity.

10. The method of claim 9 additionally comprising the step of communicating the securitizing the combined risk across a digital communications network.

11. Automated apparatus for generating risk models for relative groups of individuals, the apparatus comprising:
a. a processor in digital communication with a digital storage, the digital storage storing executable code operative with the processor to:
i. store multiple rate tiers in an automated database accessible via a digital communications network, each rate tier based upon a modeled risk, wherein the risk comprises one or more of: age, smoking status, and preexisting condition;
ii. designate multiple combinations of risk criteria;
iii. link each combination of risk criteria with a rate tier in the automated database;
iv. designate five hundred or less persons as a small entity;
v. link one or more risk criteria with each person in the small entity;
vi. repeat steps iv. and v. for multiple small entities;
vii. combine the multiple small entities to form a large entity; and
viii. generate multiple risk models for the large entity based upon the number of persons in the large entity and the risk criteria for each person in the small entities.

12. The apparatus of claim 11 wherein the executable code is further operative with the processor to calculate changes to the rate tier based upon periodic updates.

13. The apparatus of claim 12 wherein the large entity comprises five thousand or more persons.

14. The apparatus of claim 13 the executable code is additionally operative with the processor to model a risk performance for the small entity.

15. The apparatus of claim 14 the executable code is additionally operative with the processor to model a risk performance for the large entity.

16. The apparatus of claim 15 wherein the risk performance for the large entity outperforms the performance of the small entity.

17. The apparatus of claim 16 wherein the performance comprises a total cost of health care services.

18. The apparatus of claim 16 wherein the performance comprises a total quality of health care services.

19. The apparatus of claim 16 the executable code is additionally operative with the processor to securitize combined risk according to the multiple risk models for the large entity.

20. The apparatus of claim 19 the executable code is additionally operative with the processor to securitize the combined risk across a digital communications network.
